(19) United States
(12) Patent Application Publication
(10) Pub. No.: US 2026/0221697 A1
(43) Pub. Date: Jul. 30, 2026

(54) ELECTRICAL CONNECTOR

(71) Applicant: LOTES CO., LTD, Keelung (TW)

(72) Inventors: Yu-Lun Tsai, Keelung (TW); Meng-Lin Hsieh, Keelung (TW); Ren-Fei Yang, Guangzhhou (CN); Wen-Chang Chang, Keelung (CN)

(21) Appl. No.: 19/454,576

(22) Filed: Jan. 21, 2026

(30) Foreign Application Priority Data
Jan. 25, 2025 (CN) 202520145449.0
Sep. 9, 2025 (CN) 202511287593.9
Sep. 9, 2025 (CN) 202521943172.2

(51) Int. Cl. H01R 13/6594; H01R 12/72; H01R 13/6585

(52) U.S. Cl. CPC H01R 13/6594; H01R 12/722; H01R 13/6585

(57) ABSTRACT

An electrical connector includes a shell, a plurality of terminal modules and a grounding member. Each terminal module includes an insulating member and a signal terminal. The signal terminal includes a signal connecting portion having a signal contact portion. The signal contact portion is connected downward to a signal pad of a circuit board. The signal connecting portion is located between two adjacent conductive partition plates. A bottom portion of each conductive partition plate has a flat abutting surface. The grounding member includes a plurality of grounding elastic arms. The signal contact portion is located between two grounding elastic arms. When the shell is fixed on the circuit board, the grounding elastic arms abut downward against grounding pads of the circuit board and abut upward against the abutting surface, and a maximum gap between the grounding elastic arms and the grounding pads is less than or equal to 0.06 mm.

### CROSS-REFERENCE TO RELATED PATENT APPLICATION

This non-provisional application claims priority to and the benefit of, pursuant to 35 U.S.C. § 119(a), patent application Serial No. CN202511287593.9, filed in China on Sep. 9, 2025, patent application Serial No. CN202521943172.2, filed in China on Sep. 9, 2025, and patent application Serial No. CN202520145449.0, filed in China on Jan. 21, 2025. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector transmitting high-frequency signals.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing electrical connector generally includes a plurality of signal terminals, and the signal terminals are connected to a circuit board. When the electrical connector transmits high-frequency signals, crosstalk between the signal terminals often affects signal integrity, thereby affecting the high-frequency performance of the electrical connector. Inside the electrical connector, a shielding structure is generally provided between the signal terminals to separate the signal terminals, so as to reduce the crosstalk between the signal terminals inside the electrical connector. However, in order for signal contact portions of the signal terminals to be connected to the circuit board, these signal contact portions are generally exposed outside the electrical connector. In this case, the crosstalk at the signal contact portions becomes an important factor restricting the high-frequency performance of the electrical connector.

Therefore, a heretofore unaddressed need to design an electrical connector exists in the art to address the aforementioned deficiencies and inadequacies.

### SUMMARY

The present invention is directed to an electrical connector, which may reduce a gap between grounding elastic arms and a circuit board, and reduce the crosstalk at signal contact portions.

To achieve the foregoing objective, the present invention adopts the following technical solution:

An electrical connector is configured to be mounted downward onto a circuit board. The electrical connector includes: a shell, fixed to the circuit board; a plurality of terminal modules, arranged in a row along a left-right direction and accommodated in the shell, wherein each of the terminal modules comprises an insulating member and a signal terminal fixed to the insulating member, the signal terminal comprises a signal connecting portion, the signal connecting portion passes downward beyond the insulating member, the signal connecting portion has a signal contact portion, the signal contact portion is downward connected to a signal pad of the circuit board, the signal connecting portion is located between two adjacent conductive partition plates, and a bottom portion of each of the conductive partition plates has an abutting surface being flat; and a grounding member, located below the shell, wherein the grounding member comprises a plurality of grounding elastic arms, the signal contact portion is located between two of the grounding elastic arms, and the grounding elastic arms are located below the abutting surface. When the shell is fixed on the circuit board, the grounding elastic arms abut downward against grounding pads of the circuit board and abut upward against the abutting surface, and a maximum gap between the grounding elastic arms and the grounding pads is less than or equal to 0.06 mm.

In certain embodiments, when the shell is fixed on the circuit board, the grounding elastic arms and the abutting surface are completely attached, and no gap exists between the grounding elastic arms and the grounding pads.

In certain embodiments, the grounding member comprises a grounding body portion and the plurality of grounding elastic arms, the grounding body portion is fixed to the conductive partition plates, the grounding elastic arms extend forward and/or backward from the grounding body portion, the grounding elastic arms are arranged in a row along the left-right direction, each of the grounding elastic arms comprises a first section, a second section and a bending section connecting the first section and the second section, the bending section passes downward beyond the first section and the second section, and when the shell is fixed on the circuit board, bottom surfaces of the first section, the second section and the bending section are flush.

In certain embodiments, the shell comprises a flat bottom surface, the abutting surface is a part of the flat bottom surface, two adjacent second sections are connected by a connecting rod, the connecting rod abuts upward against the flat bottom surface and is movable on the flat bottom surface, the connecting rod has a grounding finger extending toward a direction away from the second sections, and the grounding finger is configured to be connected to a corresponding one of the grounding pads.

In certain embodiments, the terminal modules are arranged in two rows along a front-rear direction, the grounding body portion is located between the signal contact portions of the terminal modules in the two rows, the grounding body portion comprises a plurality of fixing portions, a plurality of first elastic fingers, a plurality of second elastic fingers and a plurality of connecting arms, the fixing portions are fixed to the shell, the grounding elastic arms extend forward and backward from the fixing portions, each of the connecting arms connects two adjacent ones of the fixing portions, the first elastic fingers and the second elastic fingers are respectively located at a front side and a rear side of the connecting arms, extension directions of the first elastic fingers and the second elastic fingers are opposite to each other, end portions of the first elastic fingers and end portions of the second elastic fingers are configured to be connected to the grounding pads of the circuit board, and, along the front-rear direction, each of the first elastic fingers and a corresponding one of the second elastic fingers are provided side-by-side.

To achieve the foregoing objective, the present invention further adopts the following technical solution:

An electrical connector is configured to be mounted downward onto a circuit board. The electrical connector includes: a shell, fixed to the circuit board; a plurality of terminal modules, arranged in a row along a left-right direction and accommodated in the shell, wherein each of the terminal modules comprises an insulating member and a signal terminal fixed to the insulating member, the signal terminal comprises a signal connecting portion, the signal connecting portion passes downward beyond the insulating member, the signal connecting portion has a signal contact portion, the signal contact portion is downward connected to a signal pad of the circuit board, the signal connecting portion is located between two adjacent conductive partition plates, and a bottom portion of each of the conductive partition plates has an abutting surface; and a grounding member, located below the shell, wherein the grounding member comprises a plurality of grounding elastic arms, the signal contact portion is located between two of the grounding elastic arms, and the grounding elastic arms are located below the abutting surface. When the shell is fixed on the circuit board, each of the grounding elastic arms comprises an upper abutting region and a lower abutting region that are vertically overlapped, the lower abutting region abuts downward against grounding pads of the circuit board, and the upper abutting region abuts upward against the abutting surface.

In certain embodiments, the bottom portion of each of the conductive partition plates is provided with an elastic section, and the elastic section has the abutting surface.

In certain embodiments, the grounding member further comprises a grounding body portion, the grounding elastic arms extend forward and/or backward from the grounding body portion, the grounding elastic arms are arranged in a row along the left-right direction, each of the grounding elastic arms comprises a first section, a second section and a bending section connecting the first section and the second section, the bending section comprises the upper abutting region and the lower abutting region, and when the shell is fixed on the circuit board, bottom surfaces of the first section, the second section and the bending section are flush.

In certain embodiments, the terminal modules are arranged in two rows along a front-rear direction, the grounding body portion is located between the signal contact portions of the terminal modules in the two rows, the grounding body portion comprises a plurality of fixing portions, a plurality of first elastic fingers, a plurality of second elastic fingers and a plurality of connecting arms, the fixing portions are fixed to the shell, the grounding elastic arms extend forward and backward from the fixing portions, each of the connecting arms connects two adjacent ones of the fixing portions, the first elastic fingers and the second elastic fingers are respectively located at a front side and a rear side of the connecting arms, extension directions of the first elastic fingers and the second elastic fingers are opposite to each other, and end portions of the first elastic fingers and end portions of the second elastic fingers are configured to be connected to the grounding pads of the circuit board.

In certain embodiments, the abutting surface is a flat plane, and when the shell is fixed on the circuit board, the grounding elastic arms and the abutting surface are completely attached, and no gap exists between the grounding elastic arms and the grounding pads.

Compared to the related art, the present invention has the following beneficial effects:

The grounding member is provided to be connected to the circuit board to shield the signal contact portions. After the grounding elastic arms abut against the circuit board, the grounding elastic arms abut upward against the abutting surface. In this process, the grounding elastic arms are gradually attached to the abutting surface. Since the abutting surface is flat, the grounding elastic arms also become relatively flat, and a maximum gap between the grounding elastic arms and the circuit board becomes relatively small, which may significantly reduce crosstalk at the signal contact portions. When the maximum gap between the grounding elastic arms and the circuit board is less than or equal to 0.06 mm, far-end crosstalk of the electrical connector may approximately reach the PCIe 6.0 Specification standard.

Each grounding elastic arm has an upper abutting region and a lower abutting region overlapping vertically. After the lower abutting region abuts against the circuit board, the upper abutting region abuts upward against the abutting surface. In the overlapping region of the upper abutting region and the lower abutting region, there is no gap among the abutting surface, the grounding elastic arm and the grounding pad, thereby improving the shielding effect of the grounding member on the signal contact portions.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of an electrical connector and a circuit board according to certain embodiments of the present invention.

FIG. 2 is an exploded view of FIG. 1.

FIG. 3 is a schematic view of an electrical connector according to certain embodiments of the present invention.

FIG. 4 is an enlarged view of a region A in FIG. 3.

FIG. 5 is a schematic view of the grounding member in FIG. 3 before being fixed to the shell.

FIG. 6 is a side view of the grounding elastic arms before abutting against grounding pads of the circuit board according to certain embodiments of the present invention.

FIG. 7 is an enlarged view of a region B in FIG. 6.

FIG. 8 is a side view of the grounding elastic arms after abutting against grounding pads of the circuit board according to certain embodiments of the present invention.

FIG. 9 is an enlarged view of a region C in FIG. 8 in an ideal case.

FIG. 10 is a schematic view of FIG. 9 in a non-ideal case.

FIG. 11 is a high-frequency analysis chart of far-end crosstalk of an electrical connector according to certain embodiments of the present invention.

FIG. 12 is a schematic view of an electrical connector according to another embodiment of the present invention.

FIG. 13 is a schematic view of an electrical connector according to a further embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

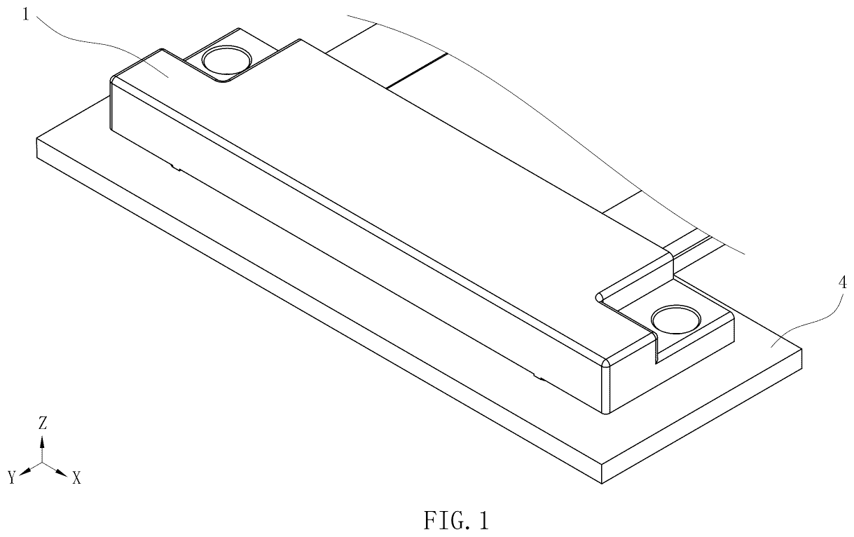

The description will be made as to the embodiments of the present invention in conjunction with the accompanying drawings in FIGS. 1-13. In accordance with the purposes of this invention, as embodied and broadly described herein, this invention, in one aspect, relates to an electrical connector.

In the electrical connector according to certain embodiments of the present invention, a left-right direction is defined as an X-axis, where a leftward direction is the positive direction of the X-axis; a front-rear direction is defined as a Y-axis, where a forward direction is the positive direction of the Y-axis; and a vertical direction is defined as a Z-axis, where an upward direction is the positive direction of the Z-axis.

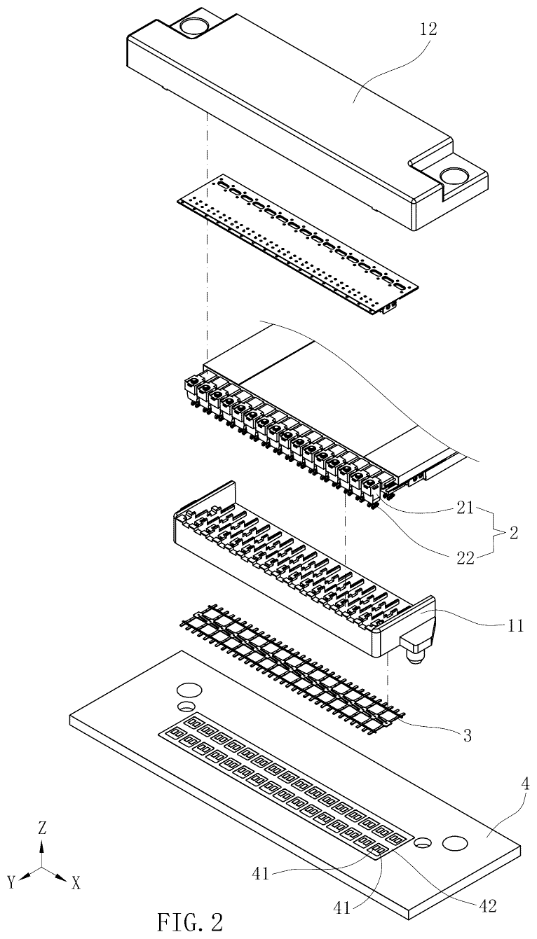

As shown in FIG. 1 and FIG. 2, the electrical connector according to certain embodiments of the present invention is configured to be mounted downward onto a circuit board 4, and includes a shell 1, a plurality of terminal modules 2 accommodated in the shell 1 and a grounding member 3.

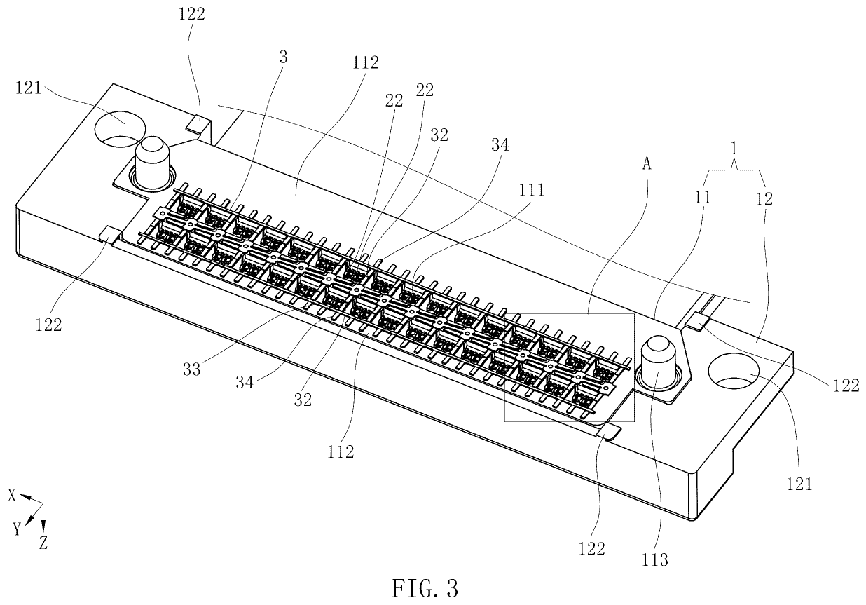

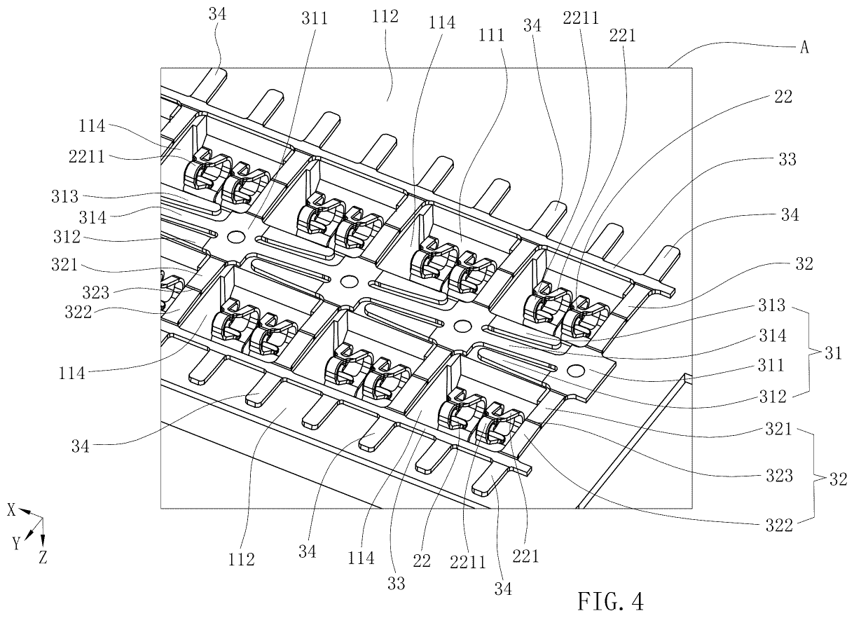

As shown in FIG. 2, FIG. 3 and FIG. 4, the terminal modules 2 are arranged in a row along the left-right direction and are arranged in two rows along the front-rear direction. Each terminal module 2 includes an insulating member 21 and two signal terminals 22 fixed to the insulating member 21. Each signal terminal 22 includes a signal connecting portion 221. The signal connecting portion 221 passes downward beyond the insulating member 21, and the signal connecting portion 221 has a signal contact portion 2211. The signal contact portion 2211 is downward connected to a signal pad 41 of the circuit board 4.

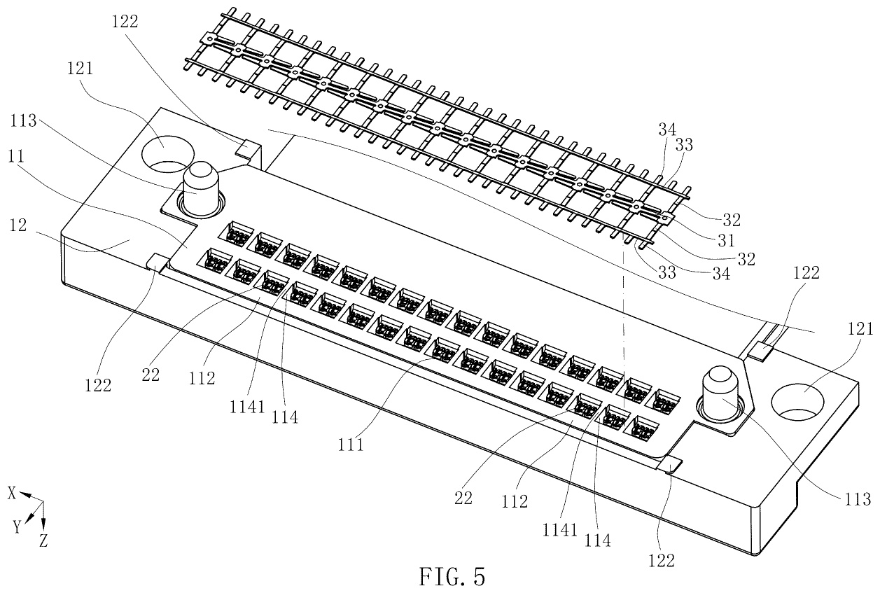

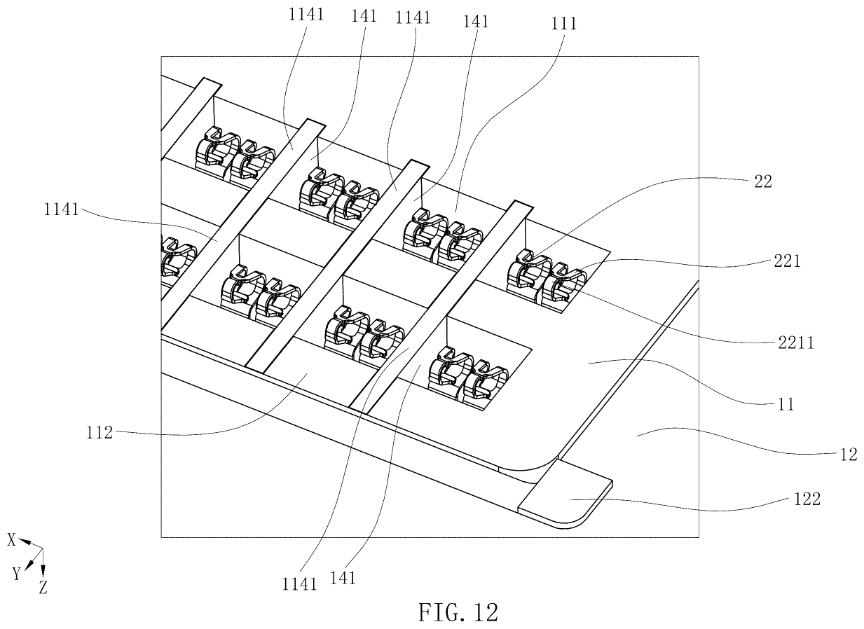

The shell 1 includes a first shell 11 and a second shell 12. The first shell 11 and the second shell 12 are both made of conductive material, and they may be formed by metal injection molding or may be formed by plating metal onto plastic shells. The first shell 11 is provided with two rows of accommodating grooves 111, and each terminal module 2 is accommodated in a corresponding accommodating groove 111. As shown in FIG. 5, the conductive partition plates 114 are partitions between adjacent accommodating grooves 111. The conductive partition plates 114 are integrally formed with the first shell 11, and each of them separates two adjacent accommodating grooves 111 in the left-right direction. In other embodiments, as shown in FIG. 12, the conductive partition plates 114 may also be partition plates assembled to the first shell 11 and used to separate the two adjacent terminal modules 2. The first shell 11 or the second shell 12 may also be made of insulating material.

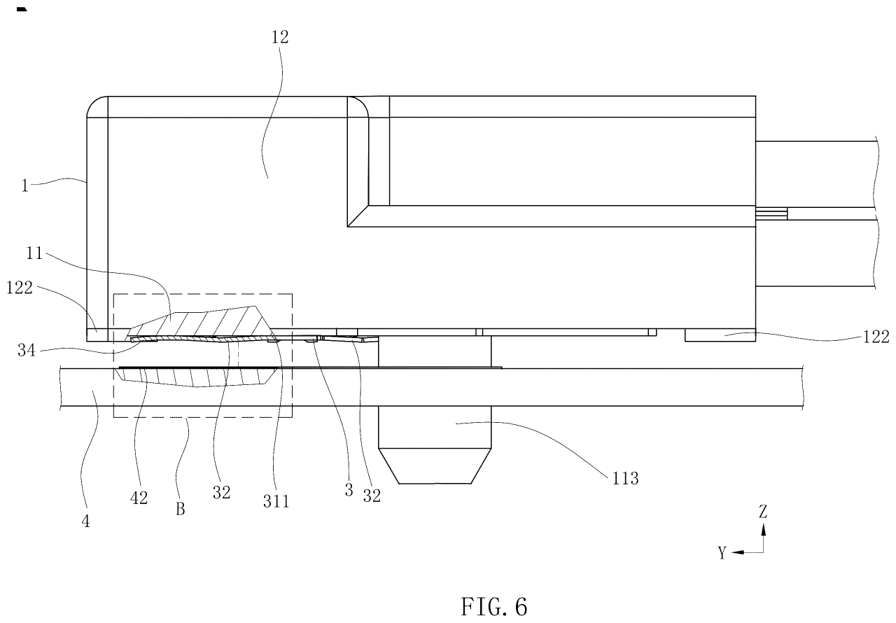

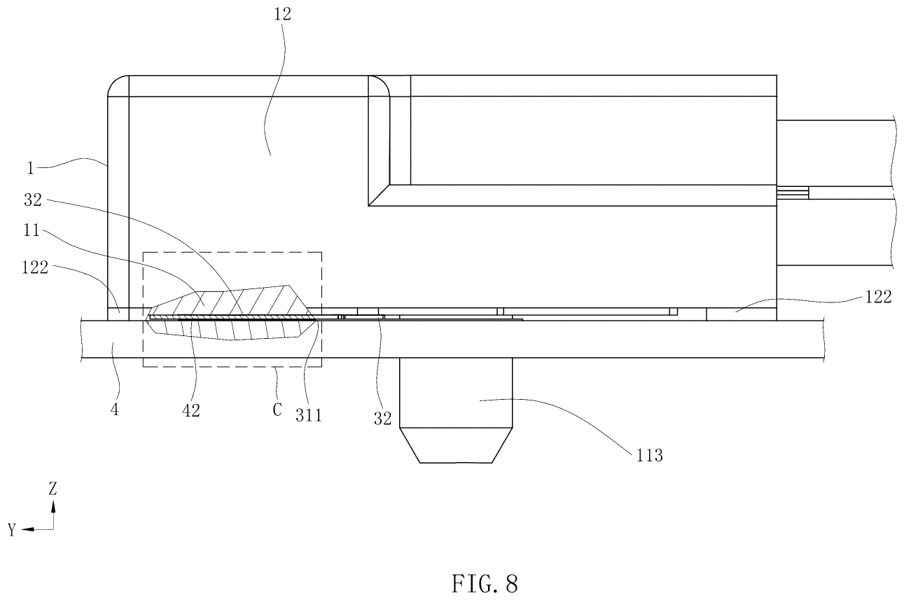

As shown in FIG. 5, FIG. 6 and FIG. 8, the second shell 12 is provided to cover on the first shell 11 and is fixed downward to the circuit board 4, such that the signal terminals 22 accommodated in the first shell 11 are in contact with the circuit board 4 by a part of the pressure applied by the second shell 12. The first shell 11 includes a flat bottom surface 112 and positioning posts 113 extending downward beyond the bottom surface 112. The conductive partition plates 114 have abutting surfaces 1141, and each abutting surface 1141 is a part of the flat bottom surface 112 and is a flat surface. The positioning posts 113 are fixed into positioning slots of the circuit board 4. Four corners of the second shell 12 are respectively provided with protruding blocks 122 protruding downward. The protruding blocks 122 are used to abut against the circuit board 4. The second shell 12 further includes screw holes 121 matched with the circuit board 4, and is fixed to the circuit board 4 by screws.

As shown in FIG. 3, FIG. 4 and FIG. 5, the grounding member 3 is located below the first shell 11. The grounding member 3 includes a grounding body portion 31 and a plurality of grounding elastic arms 32. The grounding body portion 31 is fixed to the conductive partition plates 114, and the grounding elastic arms 32 extend forward and rearward from the grounding body portion 31. The grounding elastic arms 32 are arranged in rows along the left-right direction and arranged in two rows along the front-rear direction. The grounding elastic arms 32 in the two rows are arranged symmetrically.

The grounding body portion 31 includes a plurality of fixing portions 311, a plurality of first elastic fingers 312, a plurality of second elastic fingers 313 and a plurality of connecting arms 314. The fixing portions 311 are soldered to the flat bottom surface 112, and the grounding elastic arms 32 extend forward and backward from the fixing portions 311. The connecting arms 314 connect two adjacent fixing portions 311. The first elastic fingers 312 and the second elastic fingers 313 are respectively located at a front side and a rear side of the connecting arms 314. The first elastic fingers 312 extend from right to left, and a width of each first elastic finger 312 in the front-rear direction gradually decreases along its extension direction. End portions of the first elastic fingers 312 are configured to be connected to the grounding pads 42 of the circuit board 4. The second elastic fingers 313 extend from left to right, and a width of each second elastic finger 313 in the front-rear direction gradually decreases along its extension direction. End portions of the second elastic fingers 313 are configured to be connected to the grounding pads 42 of the circuit board 4. Along the front-rear direction, each first elastic finger 312 and the corresponding second elastic finger 313 are provided side-by-side.

Each grounding elastic arm 32 is located below a corresponding abutting surface 1141. Each grounding elastic arm 32 includes a first section 321, a second section 322 and a bending section 323 connecting the first section 321 and the second section 322. The first section 321 is connected to the fixing portion 311, and the bending section 323 passes downward beyond the first section 321 and the second section 322. The second sections 322 of the grounding elastic arms 32 in one row are connected by a connecting rod 33. The connecting rod 33 abuts upward against the flat bottom surface 112 and is movable on the flat bottom surface 112. The connecting rod 33 has a grounding finger 34 extending toward a direction away from the second sections 322, and the grounding finger 34 is configured to be connected to a corresponding grounding pad 42.

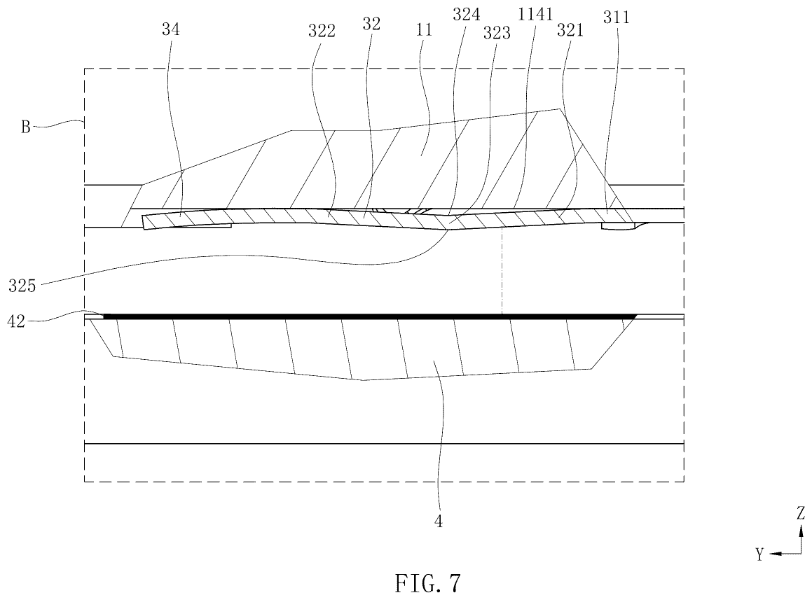

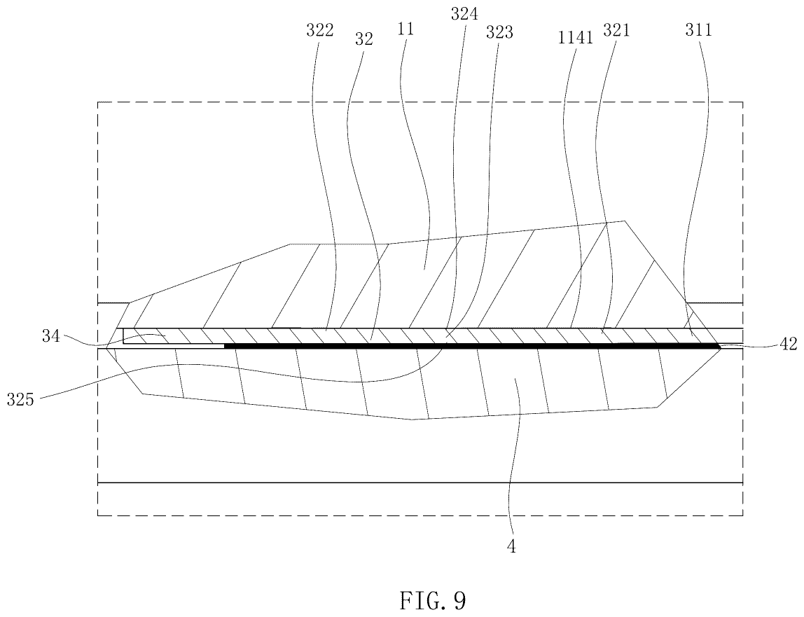

As shown in FIG. 7, FIG. 8 and FIG. 9, in a process in which the electrical connector is mounted onto the circuit board 4, the signal contact portions 2211 abut against the signal pads 41, and the grounding elastic arms 32, the first elastic fingers 312, the second elastic fingers 313 and the grounding fingers 34 abut against the grounding pads 42. After the second shell 12 is fixed to the circuit board 4 by screws, the second shell 12 applies a downward pressure to the first shell 11, and this downward pressure is transmitted to the grounding member 3 by the flat bottom surface 112 of the first shell 11. Under the action of the pressure, the connecting rod 33 moves in a direction away from the fixing portions 311. In this case, the grounding elastic arms 32 are gradually flattened.

After the first shell 11 and the second shell 12 are completely fixed to the circuit board 4, the whole grounding member 3 is pressed into a flat plate. The grounding member 3 is attached tightly upward to the flat bottom surface 112 of the first shell 11, and is attached tightly downward to the grounding pads 42 of the circuit board 4. Bottom surfaces of the first sections 321, the second sections 322 and the bending sections 323 are flush. It should be noted that, due to the existence of tolerances in the manufacturing process, the flat bottom surface 112 and the grounding pads 42 may not be completely flat. Therefore, in certain embodiments of the present invention, each of the abutting surfaces 1141 of the conductive partition plates 114 is designed as a flat surface as a priority. After the grounding elastic arms 32 abut against the circuit board 4, the grounding elastic arms 32 may be attached to the abutting surfaces 1141, and a maximum gap L between the grounding elastic arms 32 and the grounding pads 42 is less than or equal to 0.06 mm.

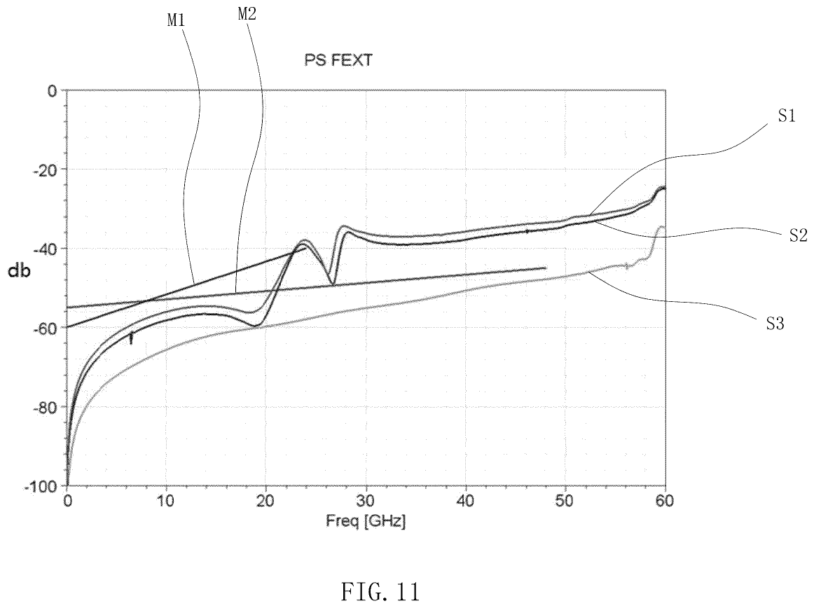

As shown in FIG. 11, S1, S2 and S3 respectively show the high-frequency analysis chart of far-end crosstalk when the maximum gap L between the grounding elastic arms 32 and the grounding pads 42 is 0.06 mm, 0.03 mm and 0 mm, and M1 and M2 are specification lines of PCIe 6.0 and PCIe 7.0, respectively. When the maximum gap L between the grounding elastic arms 32 and the circuit board 4 is less than or equal to 0.06 mm, the far-end crosstalk of the electrical connector may approximately reach the specification standard of PCIe 6.0. When the maximum gap L between the grounding elastic arms 32 and the circuit board 4 is 0 mm, the far-end crosstalk of the electrical connector may satisfy the specification standard of PCIe 7.0.

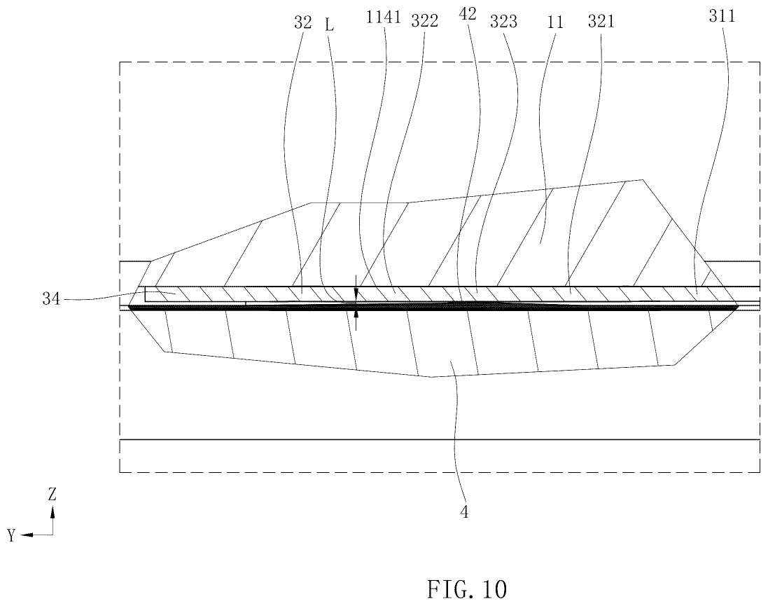

As shown in FIG. 9 and FIG. 10, each grounding elastic arm 32 includes an upper abutting region 324 and a lower abutting region 325 overlapping vertically. Generally, the upper abutting region 324 and the lower abutting region 325 are respectively located on an upper surface and a bottom surface of the bending section 323. After the first shell 11 and the second shell 12 are completely fixed to the circuit board 4, the lower abutting region 325 abuts against the grounding pads 42, and the upper abutting region 324 abuts against the abutting surfaces 1141. In an ideal case, the upper abutting region 324 may be the entire upper surface of the grounding elastic arm 32, and the lower abutting region 325 may be the entire lower surface of the grounding elastic arm 32. After the first shell 11 and the second shell 12 are completely fixed to the circuit board 4, the entire grounding elastic arm 32 is flattened, the entire upper surface of the grounding elastic arm 32 abuts against the abutting surface 1141, and the entire lower surface of the grounding elastic arm 32 abuts against the grounding pads 42.

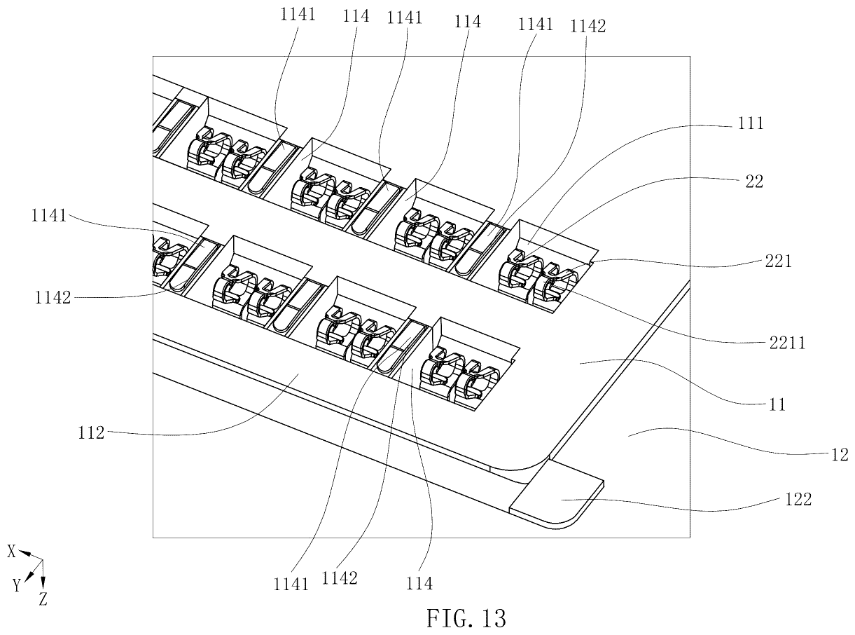

In the embodiment as shown in FIG. 13, the bottom portion of each conductive partition plate 114 is provided with an elastic section 1142, and the abutting surface 1141 is formed on the elastic section 1142. The elastic section 1142 is an elastic arm made of a conductive material such as metal, etc. In other embodiments, the elastic section 1142 may also be an elastic bottom portion made of an elastic material such as a conductive rubber, etc. In these embodiments, the abutting surface 1141 may be flat or may be non-flat. Under the action of pressure, the elastic section 1142 may elastically deform, and the abutting surface 1141 of the elastic section 1142 may adapt to the shape of the grounding elastic arm 32, such that when the grounding elastic arm 32 abuts upward against the abutting surface 1141, the abutting surface 1141 may be attached tightly to the grounding elastic arm 32. Certain portions of the abutting surface 1141 may also deform together with the grounding elastic arm 32, such that even when the abutting surface 1141 is not flat, they do not hinder the flattening of the grounding elastic arm 32.

In sum, the electrical connector 100 according to certain embodiments of the present invention has the following beneficial effects:

The grounding member 3 is provided to be connected to the circuit board 4 to shield the signal contact portions 2211. After the grounding elastic arms 32 abut against the circuit board 4, the grounding elastic arms 32 abut upward against the abutting surfaces 1141. In this process, the grounding elastic arms 32 are gradually attached to the abutting surfaces 1141. Since each abutting surface 1141 is flat, the grounding elastic arms 32 also become relatively flat, and the maximum gap L between the grounding elastic arms 32 and the circuit board 4 becomes relatively small, which may significantly reduce crosstalk at the signal contact portions 2211. When the maximum gap L between the grounding elastic arms 32 and the circuit board 4 is less than or equal to 0.06 mm, the far-end crosstalk of the electrical connector may approximately reach the PCIe 6.0 Specification standard.

Each grounding elastic arm 32 has an upper abutting region 324 and a lower abutting region 325 overlapping vertically. After the lower abutting region 325 abuts against the circuit board 4, the upper abutting region 324 abuts upward against the abutting surfaces 1141. In the overlapped region of the upper abutting region 324 and the lower abutting region 325, there is no gap among the abutting surface 1141, the grounding elastic arm 32 and the grounding pad 42, thereby improving the shielding effect of the grounding member 3 on the signal contact portions 2211.

The second sections 322 of two adjacent grounding elastic arms 32 are connected by the connecting rod 33, and the grounding finger 34 is provided on the connecting rod 33, such that the two adjacent second sections 322 may share an electric potential, thus increasing the grounding loop and improving the shielding effect. The connecting rod 33 is movable on the flat bottom surface 112. When the grounding elastic arms 32 abut against the grounding pads 42, the second sections 322 may move together with the connecting rod 33 in a direction away from the first sections 321, such that the bending sections 323 may be unfolded. Under the pressure from the grounding pads 42 and the abutting surfaces 1141, the bottom surfaces of the first sections 321, the second sections 322 and the bending sections 323 may be flush.

The grounding body portion 31 includes the first elastic fingers 312, the second elastic fingers 313 and the connecting arms 314, thus reducing the crosstalk between the signal contact portions 2211 in the two rows in the front-rear direction. Extending directions of the first elastic fingers 312 and the second elastic fingers 313 are opposite to each other. After the end portions of the first elastic fingers 312 and the end portions of the second elastic fingers 313 are connected to the grounding pads 42, even if the first elastic fingers 312 and the second elastic fingers 313 are not completely flattened, viewing backward from front thereof, there is no gap between each first elastic finger 312 and the corresponding second elastic finger 313.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, configured to be mounted downward onto a circuit board, the electrical connector comprising:
a shell, fixed to the circuit board;
a plurality of terminal modules, arranged in a row along a left-right direction and accommodated in the shell, wherein each of the terminal modules comprises an insulating member and a signal terminal fixed to the insulating member, the signal terminal comprises a signal connecting portion, the signal connecting portion passes downward beyond the insulating member, the signal connecting portion has a signal contact portion, the signal contact portion is downward connected to a signal pad of the circuit board, the signal connecting portion is located between two adjacent conductive partition plates, and a bottom portion of each of the conductive partition plates has an abutting surface being flat; and
a grounding member, located below the shell, wherein the grounding member comprises a plurality of grounding elastic arms, the signal contact portion is located between two of the grounding elastic arms, and the grounding elastic arms are located below the abutting surface;
wherein when the shell is fixed on the circuit board, the grounding elastic arms abut downward against grounding pads of the circuit board and abut upward against the abutting surface, and a maximum gap between the grounding elastic arms and the grounding pads is less than or equal to 0.06 mm.

2. The electrical connector according to claim 1, wherein when the shell is fixed on the circuit board, the grounding elastic arms and the abutting surface are completely attached, and no gap exists between the grounding elastic arms and the grounding pads.

3. The electrical connector according to claim 1, wherein the grounding member comprises a grounding body portion and the plurality of grounding elastic arms, the grounding body portion is fixed to the conductive partition plates, the grounding elastic arms extend forward and/or backward from the grounding main body portion, the grounding elastic arms are arranged in a row along the left-right direction, each of the grounding elastic arms comprises a first section, a second section and a bending section connecting the first section and the second section, the bending section passes downward beyond the first section and the second section, and when the shell is fixed on the circuit board, bottom surfaces of the first section, the second section and the bending section are flush.

4. The electrical connector according to claim 3, wherein the shell comprises a flat bottom surface, the abutting surface is a part of the flat bottom surface, two adjacent second sections are connected by a connecting rod, the connecting rod abuts upward against the flat bottom surface and is movable on the flat bottom surface, the connecting rod has a grounding finger extending toward a direction away from the second sections, and the grounding finger is configured to be connected to a corresponding one of the grounding pads.

5. The electrical connector according to claim 3, wherein the terminal modules are arranged in two rows along a front-rear direction, the grounding body portion is located between the signal contact portions of the terminal modules in the two rows, the grounding body portion comprises a plurality of fixing portions, a plurality of first elastic fingers, a plurality of second elastic fingers and a plurality of connecting arms, the fixing portions are fixed to the shell, the grounding elastic arms extend forward and backward from the fixing portions, each of the connecting arms connect two adjacent ones of the fixing portions, the first elastic fingers and the second elastic fingers are respectively located at a front side and a rear side of the connecting arms, extension directions of the first elastic fingers and the second elastic fingers are opposite to each other, end portions of the first elastic fingers and end portions of the second elastic fingers are configured to be connected to the grounding pads of the circuit board, and along the front-rear direction, each of the first elastic fingers and a corresponding one of the second elastic fingers are provided side-by-side.

6. An electrical connector, configured to be mounted downward onto a circuit board, the electrical connector comprising:
a shell, fixed to the circuit board;
a plurality of terminal modules, arranged in a row along a left-right direction and accommodated in the shell, wherein each of the terminal modules comprises an insulating member and a signal terminal fixed to the insulating member, the signal terminal comprises a signal connecting portion, the signal connecting portion passes downward beyond the insulating member, the signal connecting portion has a signal contact portion, the signal contact portion is downward connected to a signal pad of the circuit board, the signal connecting portion is located between two adjacent conductive partition plates, and a bottom portion of each of the conductive partition plates has an abutting surface; and
a grounding member, located below the shell, wherein the grounding member comprises a plurality of grounding elastic arms, the signal contact portion is located between two of the grounding elastic arms, and the grounding elastic arms are located below the abutting surface;
wherein when the shell is fixed on the circuit board, each of the grounding elastic arms comprises an upper abutting region and a lower abutting region overlapping vertically, the lower abutting region abuts downward against grounding pads of the circuit board, and the upper abutting region abuts upward against the abutting surface.

7. The electrical connector according to claim 6, wherein the bottom portion of each of the conductive partition plates is provided with an elastic section, and the elastic section has the abutting surface.

8. The electrical connector according to claim 6, wherein the grounding member further comprises a grounding body portion, the grounding elastic arms extend forward and/or backward from the grounding body portion, the grounding elastic arms are arranged in a row along the left-right direction, each of the grounding elastic arms comprises a first section, a second section and a bending section connecting the first section and the second section, the bending section comprises the upper abutting region and the lower abutting region, and when the shell is fixed on the circuit board, bottom surfaces of the first section, the second section and the bending section are flush.

9. The electrical connector according to claim 8, wherein the terminal modules are arranged in two rows along a front-rear direction, the grounding body portion is located between the signal contact portions of the terminal modules in the two rows, the grounding body portion comprises a plurality of fixing portions, a plurality of first elastic fingers, a plurality of second elastic fingers and a plurality of connecting arms, the fixing portions are fixed to the shell, the grounding elastic arms extend forward and backward from the fixing portions, each of the connecting arms connects two adjacent ones of the fixing portions, the first elastic fingers and the second elastic fingers are respectively located at a front side and a rear side of the connecting arms, extension directions of the first elastic fingers and the second elastic fingers are opposite to each other, and end portions of the first elastic fingers and end portions of the second elastic fingers are configured to be connected to the grounding pads of the circuit board.

10. The electrical connector according to claim 6, wherein the abutting surface is flat, and when the shell is fixed on the circuit board, the grounding elastic arms and the abutting surface are completely attached, and no gap exists between the grounding elastic arms and the grounding pads.
